(19) United States
(12) Patent Application Publication
(10) Pub. No.: US 2005/0188100 A1
(43) Pub. Date: Aug. 25, 2005

(54) Method for local protection of label-switching paths with resource sharing

(75) Inventors: Jean-Louis Le Roux, Trebeurden (FR); Geraldine Calvignac, Pleumeur Bodou (FR); Renaud Moignard, Trebeurden (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: France Telecom SA, Paris (FR)

(21) Appl. No.: 10/503,761

(22) PCT Filed: Feb. 20, 2003
(86) PCT No.: PCT/FR03/00563

(30) Foreign Application Priority Data
Feb. 21, 2002 (FR) 02/02436

(51) Int. Cl. G06F 15/173

(52) U.S. Cl. 709/238

(57) ABSTRACT

Label switching paths in an MPLS network having plural nodes connected by IP links, each path passing through a series of network nodes and links called “elements of the path,” are protected. An element of a first path is protected by a bypass path starting from a node of the first path upstream and ending in a node of the first path downstream of the element to be protected. A certain number of resources of the network are reserved for the bypass path. An element of a second path is protected by a bypass path of the second path starting from a node of the second path upstream of the second element and ending in a node of the second path downstream of the second element. The bypass path of the second path includes at least one part of the resources reserved for the first bypass path.

The present invention relates to a method of protecting label switching paths in an MPLS (MultiProtocol Label Switching) network. The present invention particularly relates to a local protection method for such paths with resource sharing.

The MPLS Standard published under the auspices of the IETF (Internet Engineering Task Force) is a technique which is based on label switching, making it possible to create a connection-friendly network from a datagram-type network like the IP network. Detailed information concerning the MPLS protocol will be found at the www.ietf.org website.

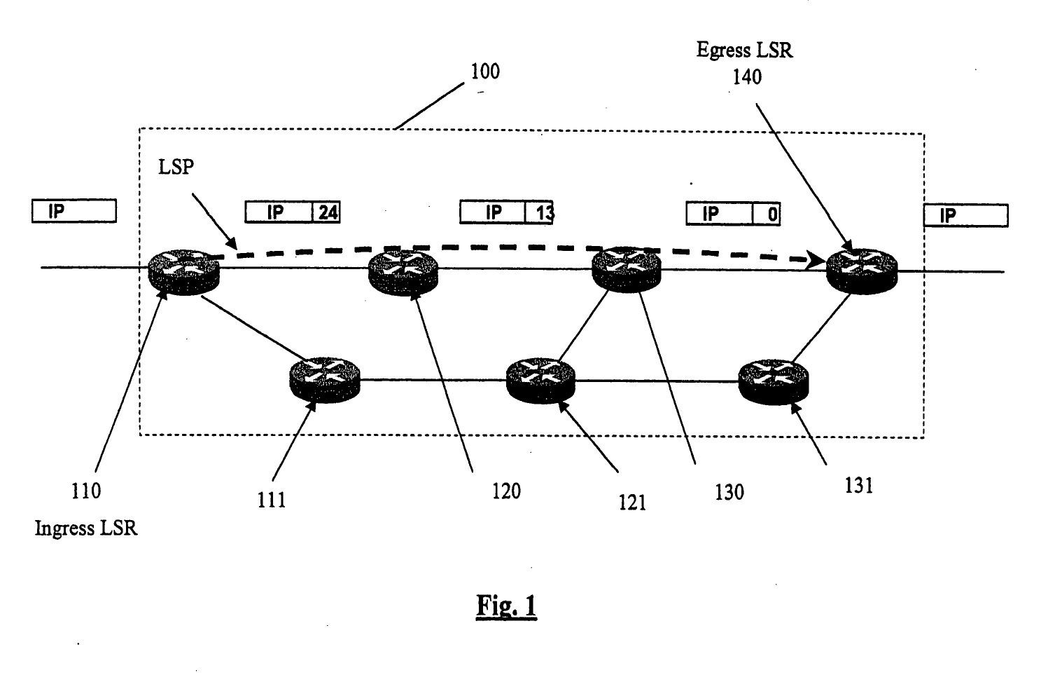

In FIG. 1, an MPLS network 100 is schematically illustrated which comprises a plurality of label switching routers called LSR, such as 110, 111, 120, 121, 130, 131, 140, mutually connected by IP links. When an IP packet arrives on a peripheral input node 110 called LSR Ingress, the latter assigns a label (here 24) to it as a function of its IP heading and the sequence of the above-mentioned packet. The router, which receives the labeled packet, replaces the label (incoming) by an outgoing label as a function of its routing table (in the concerned example, 24 is replaced by 13) and the process is repeated from node to node to the output router 140 (called Egress LSR) which deletes the label before transmitting the packet. As an alternative, the label deletion can already be carried out by the penultimate router, since the output router does not use the incoming label.

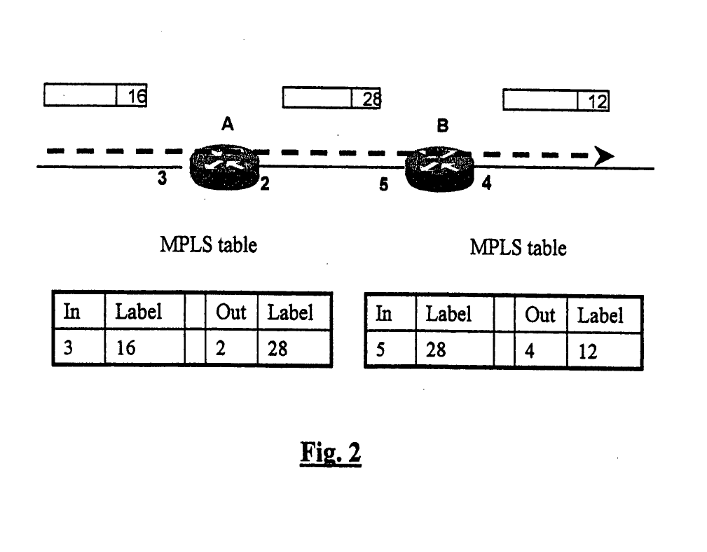

As indicated in FIG. 2, an LSR router uses the label of the incoming packet (incoming label) for determining the output port and the label of the outgoing packet (outgoing label). Thus, for example, the router A replaces the labels of the IP packets arriving at port 3 and of the value 16 by labels of the value 28; then sends the thus relabeled packets to port 2.

The path covered by a packet through the network from the input router (LSR Ingress) to the output router (LSR Egress) is called a label switched path or LSP. The routers LSR crossed by the path and differing from the input and output routers are called transit routers. On the other hand, the set of IP packets which are transmitted along a same path are called forward equivalence class or FEC.

The MPLS protocol makes it possible to force the IP packets to follow a preestablished LSP path which generally is not the optimal IP path in terms of hops or the metrics of the path. The technique of determining the path or paths to be taken is called MPLS Traffic Engineering or MPLS-TE. The path determination takes into account constraints with respect to available resources (Constraint-Based Routing), specifically in the bandwidth on the different network links. In contrast to the classic IGP routing operating according to a hop-by-hop routing mode, the determination of an LSP path takes place according to a mode called explicitly routed LSP or ET-LSP in which certain or all nodes of the path from the input router to the output router are determined. When all nodes of the path are fixed, this is an explicit routing in the strict sense. A path determined according to an explicit mode is also called an MPLS tunnel.

The determination of an MPLS tunnel or tunnels can take place in a centralized or distributed manner.

According to the distributed method also called constraint-based routing, each router is informed about the topology of the network and the constraints affecting the different links of the network. For this purpose, each router determines (determined router? translator) transmits a message to its neighbors which indicates its immediate links and the constraints (or characteristics) associated therewith. These messages are then propagated from node to node by IGP message spread according to a flooding mechanism until all routers are informed. Thus, each router has its own database (called TED for Traffic Engineering Database) providing it with the topology of the network and its constraints.

The determination of the label switching path then carried out by the input router (LSR Ingress) while also taking into account other constraints fixed by the network operator (for example, avoiding this or that node or avoiding links of this or that type). The input router thus determines, for example, by means of the Dijkstra algorithm, the shortest path satisfactory to the total of the constraints (Constraint Shortest Path First or CSPF), those affecting the links as well as those fixed by the operator. This shortest path is then signalled to the nodes of the LSP path by means of the signalization protocols known by the abbreviations RSVP-TE (Resource reSerVation Protocol for Traffic Engineering) or CR-LDP (Constrained Route Label Distribution Protocol). A description of the RSVP-TE protocol can be found in the document by D. Adwuche et al. with the title “RSVP-TE: Extensions to RSVP for LSP Tunnels” available at the above-mentioned IETF website.

These MPLS signalization protocols permit the distribution of labels along the path and the reservation of resources.

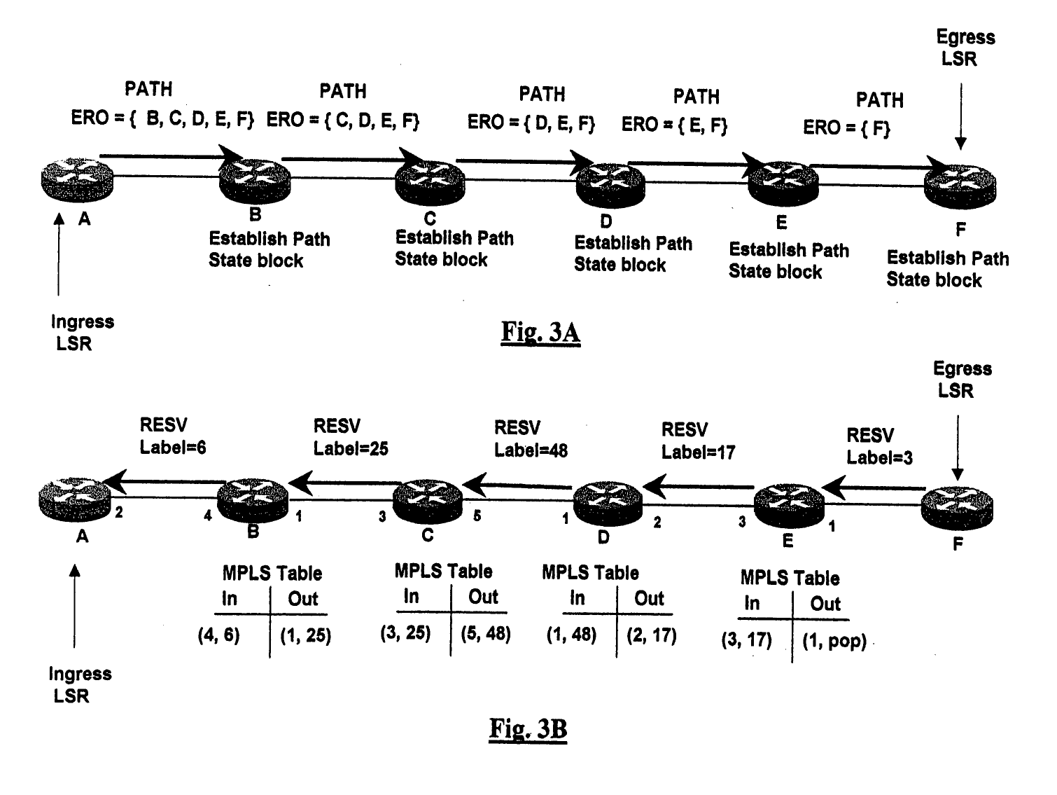

For example, if the RSVP signalization protocol is used, the input router A, as indicated in FIG. 3A, transmits a “path” message in an IP packet to the output router F. This message specifies the list of nodes through which the LSP path should pass. At each node, the “path” message establishes the path and makes a status reservation. When the “path” message arrives at the output router, an “Resv” release message is sent back via the same path to the input router, as indicated in FIG. 3B. At each node, the MPLS routing table is updated and the resource reservation is made. For example, if the resource is a bandwidth and it is desired to reserve 10 units (MHz) for the path, the bandwidths which are in each case assigned to each link are decreased by the reserved value (10) at the time of the reverse propagation of the release message/reservation. It should be noted that the resource in question (for example, the bandwidth) is a logical resource on the IP link and not a physical resource. When the release message is received by the input router, the tunnel is established.

As indicated above, the determination of LSP paths can be implemented in a centralized manner. In this case, a server knows the topology of the network and takes into account the constraints on the links and the constraints fixed by the network operator in order to determine tunnels between the input routers and the output routers. The input routers are then advised by the server of the tunnel or tunnels for which they are the input node. The tunnels are then established as indicated in FIGS. 3A and 3B. The centralized determination method has the advantage of high stability and predictability because a single device carries out the preliminary calculation of all tunnels. On the other hand, it has the inconvenience of not easily adapting to the rapid variations of the network topology, for example, in the event of a rupture of a physical connection, suppressing the IP links which it supports.

Whether they were calculated in a centralized or distributed manner, the tunnels are susceptible to being destroyed in the event of a cutting of an underlying physical connection. Relief mechanisms therefore have to be provided which permit the establishment of a new tunnel between the same input router and the same output router. A distinction can be made between restoration mechanisms establishing a relief tunnel after the cutting and protection mechanisms pre-establishing a relief tunnel anticipating a possible cutting.

The advantage of protection mechanisms is to allow a very rapid resumption of the traffic, a relief tunnel already being available. On the other hand, they result in the inconvenience of mobilizing important network resources. More precisely, the protection mechanisms known from the prior art are divided into local protection methods and from-end-to-end protection methods. In the former, local relief tunnels are pre-established in anticipation of a failing of an element (node, link) of the initial tunnel. When the failure occurs, the traffic in the local tunnel is diverted for circumventing the failing element. In the from-end-to-end protection methods, a relief tunnel is established from the input router to the output router. Contrary to the restoration methods (where the relief tunnels are created upon demand), the protection methods (where the relief tunnels are created in a preliminary manner) eat up the resources of the network.

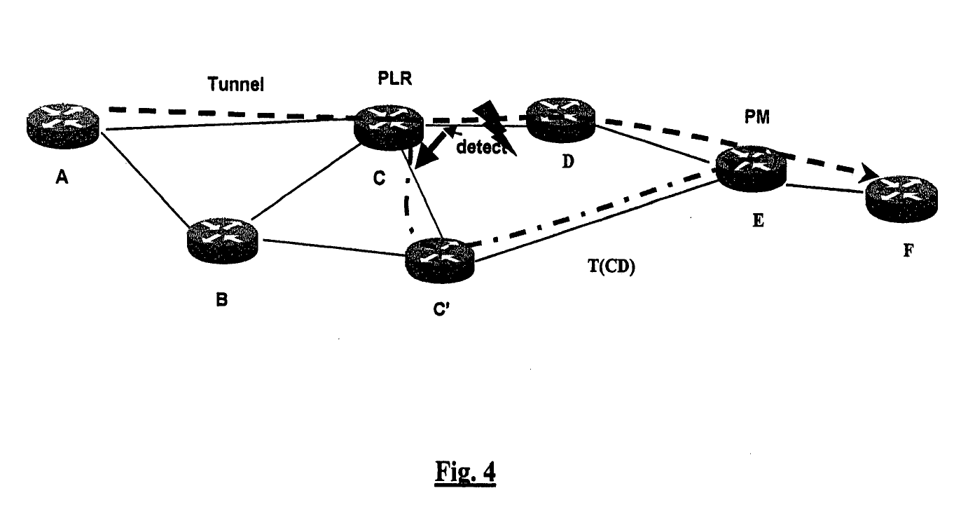

From the prior art, particularly from the document with title “Fast Reroute Techniques in RSVP-TE” by P. Pan et al. available at the above-mentioned IETF website under the reference “draft-pan-rsvp-fastereroute-00.txt”, different local protection methods (or FRR for Fast ReRoute) of a tunnel are known. The general principle of this local protection is indicated again in FIG. 4. For an element (link, node) of the tunnel to be protected, a local relief tunnel is provided for circumventing it. For example, for circumventing the CD link, a relief tunnel T(CD) is provided which has C, C′, E as the path. The upstream router, which detects and repairs the tunnel failure while orienting the packets on the relief tunnel, is called PLR (Point of Local Repair). The router downstream of the failure, where the relief tunnel rejoins the initial tunnel, is called PM (Point of Merging). In the present case, the router C detects the failure of the link DC (symbolized by a flash) by the absence of RSVP “hello” messages transmitted at regular intervals on the CD link by the router D or by an alarm of the underlying physical layer. The router C then reroutes the traffic of the initial tunnel to the bypass tunnel CC′E. The junction between the initial tunnel and the bypass tunnel is implemented in E.

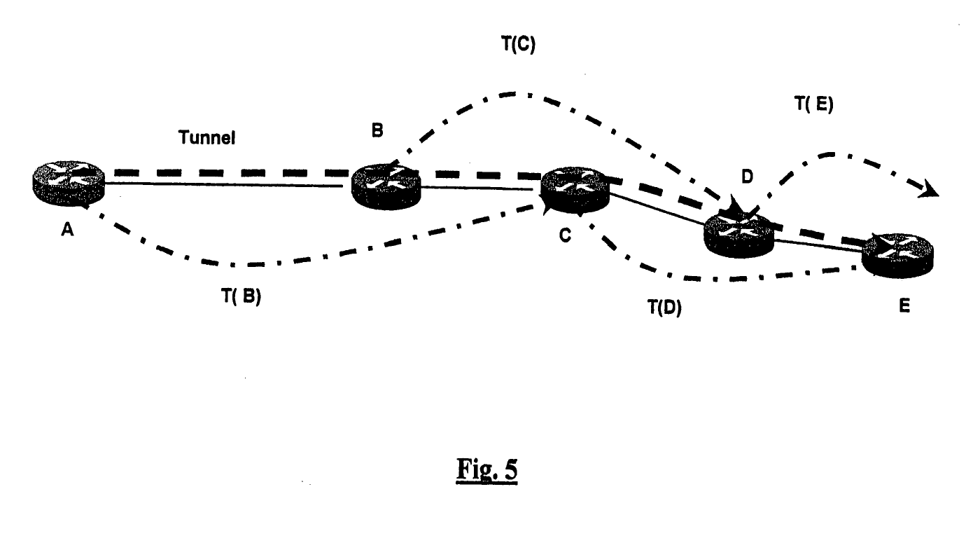

A first local protection method of the LSP path, called “one-to-one”, consists of creating a local relief tunnel, called “detour”, for each element of the path to be protected. FIG. 5 illustrates a local protection method of the “one-to-one” type. Each element K is protected by a noted detour T(K). It will be noted that a detour T(N) for a node N protects the link upstream as well as the link downstream of the node. If the path contains n nodes, it may therefore have up to (n-1) detours. If several paths are to be protected in the MPLS network, a series of detours should be provided for each of these. This protection method is therefore not extensible (scalable).

It is important to note that the detours are created dynamically at the time of the establishment of the path. Furthermore, the detours are created in a distributed manner by the transit routers of the path at the initiative of the input router. Thus, in the case of a change of the topology or of a modification of constraints of resources, the detours will not necessarily be the same for each path. The generating procedure of detours requires a modification of the RSVP signalization, as described in the above-mentioned document.

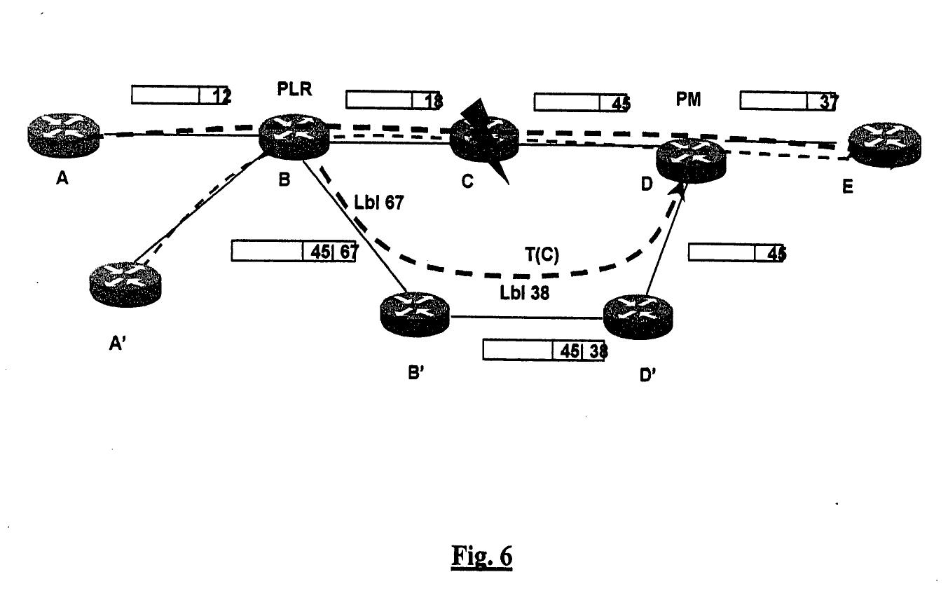

According to a second local protection method of the LSP path, called “many-to-one”, a relief tunnel, called bypass tunnel, is provided by the operator for protecting one or more elements (node, link) of the MPLS network. Such a bypass tunnel can therefore be used for relieving a plurality of paths bypassing the above-mentioned element or elements. As an example, FIG. 6 illustrates two paths to be protected: T₁=ABCDE and T₂=A′BCDE sharing the path BCDE. In the present case, the operator has provided the protection of the node C while configuring a bypass tunnel having BB′D′D as the path. This bypass tunnel permits the relieving of the two paths T₁ and T₂ in the event of the failure of the node C (or of one of the links BC, CD). Generally, a bypass tunnel permits the relieving of a plurality of paths which intersect it upstream of the failure at a common point PLR and downstream of the failure at a common point PM. The bypass tunnel takes advantage of the possibility of label stacking by assigning different hierarchical levels to them in order to reroute the packets in a transparent manner. More precisely, as indicated in FIG. 6, the routers along path T₁ switch the labels 12, 18, 45 and 37. When a failure of the node C interferes, the router B stacks a label (here 67) locally representing the bypass tunnel. At the penultimate node of the bypass tunnel (here D′), the label locally representing the bypass tunnel (here 38) is removed in such a manner that the point PM receives a label identical to that (45) of a packet which would not have been rerouted.

It is important to note that the bypass tunnels are previously determined in a static and/or centralized manner by a server without a priori taking into account the needs for resources of future LSP paths to be established. In particular, the bandwidth of the bypass tunnel cannot be sufficient for conveying the band required of the path to be protected. Thus, although a bypass tunnel is present, it will not permit a sufficient relieving of the path to the protected.

The problem on which the invention is based is that of suggesting a method of protecting LSP paths which consumes fewer resources than the protection methods known from the prior art, while ensuring a higher degree of extensibility (scalability) and a good efficiency guaranty.

The problem is solved by the object of the invention, defined as a method of protecting label switching paths in an MPLS (MultiProtocol Label Switching) network, comprising a plurality of nodes connected by IP links, a path passing through a determined series of nodes and links of the above-mentioned network, called elements of the above-mentioned path. An element of a first path having been protected by means of a path, called the bypass of the first path, starting out from a node of the first path upstream of the above-mentioned element to be protected and ending in a node of the first path downstream of the above-mentioned element to be protected, and a certain number of resources of the network having been reserved for the above-mentioned bypass path of the first path, the latter being active in the case of a failure of the above-mentioned element of the first path, an element of a second path is protected by means of a path called the bypass of the second path, starting out from a node of the second path upstream of this element and ending in a node of the second path downstream of this element, the bypass path of the second path utilizing at least a portion of the reserved resources for the bypass path of the first path.

Thus, the resources of the network can be saved by dividing them between the first and second paths.

Advantageously, if the second-path element to be protected is a link, the above-mentioned bypass path of the above-mentioned second path is selected among a plurality of candidate paths not comprising the above-mentioned link, the selection being carried out by testing whether each link of the candidate path presents a failure risk independently of the failure risk of the above-mentioned link to be protected.

For this purpose, a group of links of the above-mentioned network which are affected by the failure of the above-mentioned physical element are determined for each physical element of the above-mentioned network.

Conversely, the list of the above-mentioned groups is determined to which each link of the above-mentioned network belongs.

For testing whether a link of the candidate path presents a failure risk independently of the failure risk of the above-mentioned link to be protected, it is determined whether the lists of the above-mentioned groups respectively associated with the link to be protected or with the link of the candidate path are separated.

If the second-path element to be protected is a node, the above-mentioned bypass path of the above-mentioned second path is selected among a plurality of candidate paths not comprising the above-mentioned node, the selection being carried out by testing whether each link of the candidate path presents a risk of failure independently of the risk of failure of the link, the afore-mentioned link upstream, joining the node (PLR) upstream of the above-mentioned node to be protected and this last node.

The above-mentioned characteristics of the invention as well as others will become clearer on the basis of the following description of the embodiments, the above-mentioned description being carried out by means of the attached drawings.

FIG. 1 is a view of an MPLS network known from the prior art;

FIG. 2 is a schematic view of the creation of a label switched path;

FIG. 3A is a schematic view of a first phase of the establishment procedure of an LSP path;

FIG. 3B is a schematic view of a second phase of the establishment procedure of an LSP path;

FIG. 4 is a schematic view of the local repair principle of an LSP path;

FIG. 5 is a schematic view of a distributed local protection method of an LSP path, known from the prior art;

FIG. 6 is a schematic view of a centralized local protection method of an LSP path, known from the prior art;

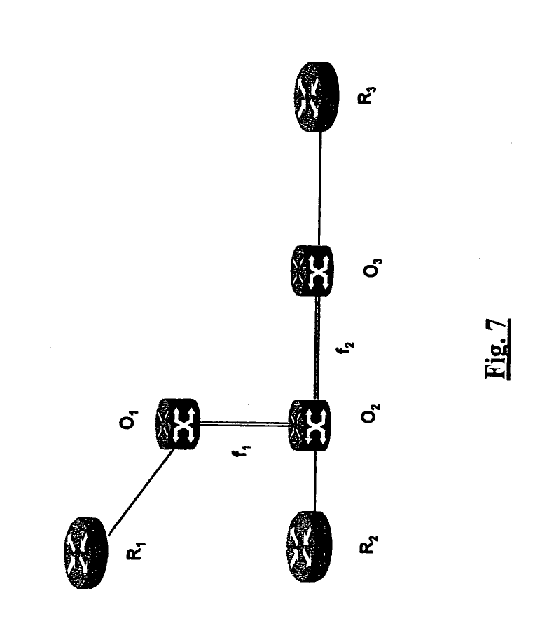

FIG. 7 is a view of the risk-sharing entity concept;

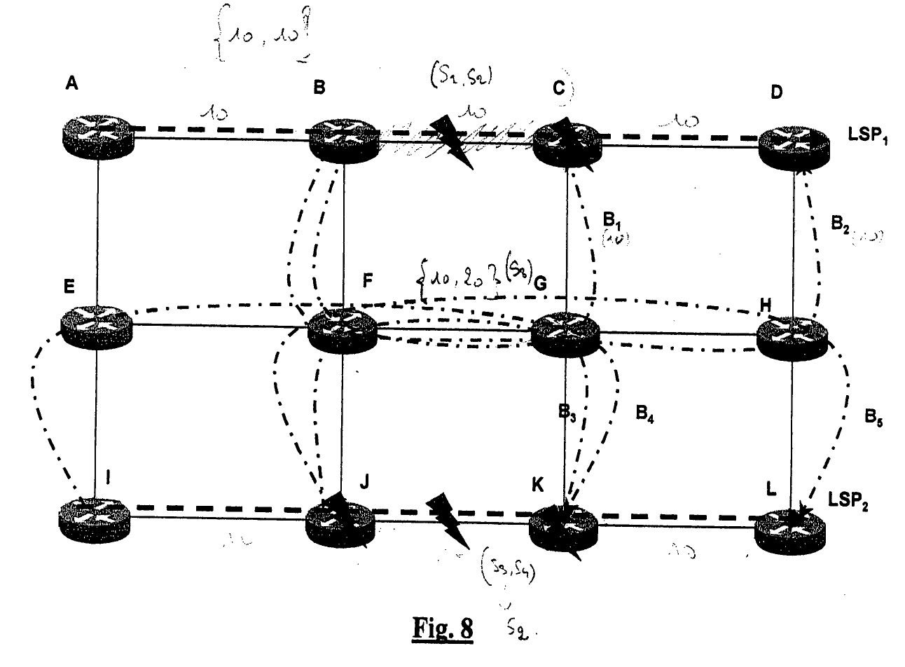

FIG. 8 is a schematic view of a method for the local protection of LSP paths according to the present invention.

The idea on which the invention is based starts out from the ascertainment that a failure in a network generally affects only a single physical element of the network at the same time. The failure of a physical element entails the failure of a certain number of IP links and/or of nodes of the network. Thus, in the event of the failure of a physical element, only certain paths will be affected. The invention is based on the idea of sharing the protection resources which allows the protecting of paths which are not affected at the same time by the failure of a same physical element. Thus, bypass tunnels protecting different paths will be able to share protection resources and save network resources, such as the bandwidth. Furthermore, by suitably proportioning the shared resources, a good guaranty will be obtained that the paths to be protected are effectively relieved in the event of a failure.

In the following, the Shared Risk Link Group (or SRLG) associated with a link will be the entirety of network links sharing a same physical resource with the above-mentioned link and all affected by the failure of this physical resource. This concept of the Shared Risk Link Group was introduced by K. Kompella et al. in a document with the title “Routing Extensions in Support of Generalized MPLS”, available at the IETF website under the reference “draft-ietf-ccamp-gmpls-routing-01.txt”. A link can belong to several SRLGs or belong to none. The SRLG list of a link is defined as the list of the SRLG in which this link would appear. Two links present an SRLG diversity if their SRLG lists have a void intersection. In particular, two links not belonging to any SRLG have an SRLG diversity.

The SRLG list concept will be better understood by means of the example of FIG. 7. It is assumed that three routers R₁, R₂, R₃ are interconnected by means of optical mode mixers (OXC) O₁, O₂, O₃. These optical mode mixers are interconnected by means of optical fibers f₁, f₂ with multiplexing WDM. It is assumed that S₁, S₂ are the SRLGs respectively associated with the fibers f₁ and f₂. The link R₁R₂ uses only the illumination path O₁-O₂, its SRLG list being {S₁}. The link R₁R₃ utilizes the illumination path O₁-O₂-O₃, its SRLG list therefore being {S₁, S₂}. The link R₂R₃ uses the illumination path O₂-O₃, its SRLG list therefore being reduced to {S₂}. It is therefore established that the links R₁R₂ and R₂R₃ have diversity of the SRLG but that the latter do not have it with link R₁R₃.

A failure of the SRLG is defined as the failure of the physical resource shared by the different elements of the SRLG. Thus, in the preceding example, a failure of the SRLG S₂ corresponds to a failure of the fiber f₂.

A failure of the SRLG can cause the failure of several links. Thus, in the preceding example, the failure of the SRLG S₂ will bring about the failure of links R₁R₃ and R₂R₃. Generally, the failure of a given SRLG will cause the failure of links whose SRLG lists contain it.

Inversely, a failure of the SRLG can occur independently of the failure of a link. Thus, in the preceding example, the failure of the link R₂O₂ connecting R₂ to O₂ causes a failure of the link R₂R₃ but not of the SRLG S₃. Generally, if a link does not belong to an SRLG, the failure of this link will not cause that of the SRLG.

In the following, it will be assumed that the probability that the network will be affected by more than one failure of a node or link or SRLG is slight.

A distinction is made between two types of bypass tunnels: those which protect a link, also called NHOP bypass (next-hop bypass) and those which protect a node or NNHOP bypass (next-next-hop bypass).

An NNHOP bypass tunnel starts at a point PLR and ends two hops downstream, or even farther. It should, of course, not use the node it protects, nor the link downstream of the PLR point. It should also present an SRLG diversity with the latter. It will be noted that an NNHOP bypass tunnel protects not only the node downstream of the PLR point but also the link downstream of the latter.

A failure risk (FR), such as a link, a node or an SRLG is also defined. Naturally, for an SRLG, the real risk of failure concerns the underlying physical resource but, for the purpose of simplification, the SRLG will be associated with the physical resource in question.

Furthermore, the tunnel failure risk group (TFRG) of a bypass tunnel B is defined as the set of failure risks which this tunnel protects. Thus, the TFRG of an NHOP bypass tunnel is the set formed by the downstream link and the SRLG list of this link. Likewise, the TRFG of an NNHOP bypass tunnel is the set formed by the node which it protects, the link connecting the point PLR with this node and the SRLG list of this link.

In the following, it will be assumed that one bypass tunnel protects a link or a node (that is, of the NHOP or NNHOP type). It will be said that two bypass tunnels present a failure risk group (FRG) diversity if:
They do not protect the same link;
they do not protect the same node;
the links they protect present an SRLG diversity.

As above, the link failure risk group (or LFRG) of a link is defined as the set of failure risks which the bypass tunnels protect which pass through this link.

Finally, the protection bandwidth of a failure risk Φ is defined by a link L of a bypass tunnel protecting Φ (in other words, whose TFRG contains Φ), and it is marked BP(Φ,L), the bandwidth reserved or to be reserved on this link for protecting Φ. It is specified that here the bandwidth is a logical bandwidth and not a physical bandwidth. More precisely, the physical bandwidth of a physical resource may contain a primary bandwidth dedicated to the normal traffic and a secondary bandwidth dedicated to the protection. The totality of the secondary protection bandwidth is not necessarily reserved and, for a given link L, a distinction is made between the current value effectively reserved for the protection rBP(L) and the maximal reservable value RBP(L).

It is now assumed that several paths have been created in the MPLS network between input routers and output routers in a centralized or distributed manner, as illustrated in the introductory part. It is endeavored to create bypass tunnels which will protect the elements (node, link) of each of these paths. The operator could have specified for certain of these elements or for the entire path that it will not be necessary to provide a protection. Likewise, it could have been specified that certain elements of the network will not be eligible for a protection function of a path. Taking into account these specifications, the method of determining the bypass tunnels operates in the following manner, successively for each of the paths to be protected and, in a path, for each element to be protected:

(1) It is determined whether a bypass tunnel already exists beginning at the PLR and, generally, if it already exists in the bypass tunnel network, the elements of the latter can be partially or completely used. Thus, bypass tunnel candidates are obtained. The bypass tunnel candidates cannot use the element to be protected.

(2) If a link is to be protected, it is determined for each link of the bypass tunnel candidate whether it presents an SRLG diversity with this link: If the answer is negative, the bypass tunnel candidate is not compatible in terms of the risk and cannot be retained.

(3) If a node is to be protected, it is determined for each link of the bypass tunnel candidate whether it presents an SRLG diversity with the link adjoining the PLR and the node to be protected: If the answer is negative, the bypass tunnel is not compatible in terms of risk and cannot be retained.

(4) If the answer is positive, on the other hand, a protection of the element considered by the bypass tunnel candidate is simulated and, for each link of the tunnel, a new bandwidth is calculated that is to be reserved, such as rBP(L)=max (BP(Φ,L)) where Φ ε LFRG(L).

(5) It is checked whether the condition rBP(L)≦RBP(L) is verified for all the links of the bypass tunnel candidate; if the answer is negative, the tunnel is not retained.

(6) The procedure is repeated for all bypass tunnel candidates.

An example will make it possible to better understand the implementation of the method of determining bypass tunnels. We will consider the MPLS network of FIG. 8 and assume that a first path LSP₁=ABCD of a 10 unit bandwidth has been established in the network. Furthermore, it is assumed that all IP links have a traffic bandwidth of 10 units, a protection bandwidth of 10 units, except for the FG link which has a protection bandwidth of 20 units. The operator's specifications indicate that only the link BC and the node C need to be aided. These two elements are protected by a first bypass tunnel NHOP B₁ and a second bypass tunnel NNHOP B₂ respectively, each having a bandwidth of 10 units. It is assumed that the SRLG list of the BC link is {S₁, S₂} and that of the FG link is {S₃} with S₁, S₂, S₃ being separate.

It is now assumed that a second path LSP₂=IJKL of a bandwidth of 10 units is to be protected. The specifications indicate that only the link JK and the nodes J and K need to be aided. No bypass tunnel is available starting from 1 and J. Using link FG of B₁ again, B₃=JFGK is considered to be the bypass tunnel candidate.

Link JK:

It is assumed that the link JK has as the list SRLG={S₃, S₄}, with S₄ being different from S₁, S₂, S₃. In this case, the bypass tunnel candidate JFGK cannot be retained because the link FG does not present SRLG diversity with the link JK. Another bypass tunnel should then be identified.

It is now assumed that the link JK has as the list SRLG={S₂}. It is successively checked whether the links JF, FG and GK have an SRLG diversity with {S₂}. If the answer is yes, the JFGK tunnel can be retained. For this to be definite, the bypass tunnel JFGK should offer a bandwidth sufficient for aiding the traffic on link JK.

The protection of JK by the bypass tunnel candidate B₃ is simulated. The following is obtained:
LFRG(JF)={JK} and rBP(JF)=10
BP (JK, JF)=10
LFRG(GK)={JK} and rBP(GK)=10
BP (JK, GK)=10
LFRG (FG)={BC, C, JK, S₁, S₂}
BP(BC,FG)=bandwidth (B₁)+bandwidth (B₂)=20
BP(JK,FG)=bandwidth (B₃)=10
BP(C,FG)=bandwidth (B₂)=10
BP(S₁,FG)=bandwidth (B₁)+bandwidth (B₂)=20
BP(S₂,FG)=bandwidth (B₁)+bandwidth (B₂)+bandwidth (B₃)=30

It is noted that this last case corresponds to a failure of the underlying physical resource of S₂. In this case, the links BC and JK are simultaneously failing and all three bypass tunnels B₁, B₂, B₃ are activated. In other words, the tunnels B₁, B₂, B₃ do not present an FRG diversity.
rBP(FG)=max (BP(Φ,FG)) where Φ ε LFRG(FG)
   that is, rBP(FG)=30≧RBP(FG). The tunnel B₃ cannot be retained.

It is now assumed that the link JK has as the list SRLG={S₄}. As above, it is checked whether the links JF, FG and GK have an SRLG diversity with {S₄}. If the answer is yes, so that the JFGK tunnel can definitely be retained, the bypass tunnel JFGK should offer a bandwidth sufficient for aiding the traffic on link JK.

The calculation of BP(JK,JF) and BP(JK,GK) is identical to the above. However, this applies to the link FG:
LFRG(FG)={BC,C,JK,S₁,S₂, S₄}
BP(BC,FG)=bandwidth (B₁)+bandwidth (B₂)=20
BP(JK,FG)=bandwidth (B₃)=10
BP(C,FG)=bandwidth (B₂)=10
BP(S₁,FG)=bandwidth (B₁)+bandwidth (B₂)=20
BP(S₂,FG)=bandwidth (B₁)+bandwidth (B₂)=20
BP(S₄,FG)=bandwidth (B₃)=10
   that is, rBP(FG)=20. Since rBP(FG)≦RBP(FG), the tunnel B₃ is retained.

Here, the protection band to be reserved is weaker because links JK and BC present an SRLG diversity. This hypothesis will be observed in the following.

Node J:

The path B₄=IEFGK is a bypass tunnel candidate which presents an SRLG diversity with the link IJ. The following is obtained:
LFRG(IE)={J} and BP(J,IE)=10
LFRG(EF)={J} and BP(J,EF)=10
LFRG(GK)={J} and BP(J,GK)=10
LFRG (FG)={BC, C, JK, J, S₁, S₂, S₄}
BP(BC,FG)=bandwidth (B₁)+bandwidth (B₂)=20
BP(C,FG)=bandwidth (B₂)=10
BP(JK,FG)=bandwidth (B₃)=10
BP(J,FG)=bandwidth (B₄)=10
BP(S₁,FG)=bandwidth (B₁)+bandwidth (B₂)=20
BP(S₂,FG)=bandwidth (B₁)+bandwidth (B₂)=20
BP(S₄,FG)=bandwidth (B₃)=10
   wherein rBP(FG)=20. The tunnel B₄ is retained because rBP(FG)≦RBP(FG). It will be noted that B₄ also permits the protection of the link IJ without the supplementary reservation of the bandwidth on link FG.

Node K:

The path B₅=JFGHL is a bypass tunnel candidate which presents an SRLG diversity with the link JK. The following is obtained:
LFRG(JF)={K} and BP(K,JF)=10
LFRG(GH)={K} and BP(K,GH)=10
LFRG(HL)={K} and BP(K,HL)=10
LFRG(FG)={BC,C,JK,J,K,S₁,S₂,S₄}
BP(BC,FG)=bandwidth (B₁)+bandwidth (B₂)=20
BP(C,FG)=bandwidth (B₂)=10
BP(JK,FG)=bandwidth (B₃)=10
BP(J,FG)=bandwidth (B₄)=10
BP(K,FG)=bandwidth (B₅)=10
BP(S₁,FG)=bandwidth (B₁)+bandwidth (B₂)=20
BP(S₂,FG)=bandwidth (B₁)+bandwidth (B₂)=20
BP(S₄,FG)=bandwidth (B₃)=10
   wherein, also here, rBP(FG)=20. The tunnel B₅ is retained because rBP(FG)≦RBP(FG). It will be noted that B₅ also permits the protection of the link KJ without the supplementary reservation of the bandwidth on link FG.

According to a first embodiment, the bypass tunnels are created in a centralized manner by a specialized server. The latter has the topology of the network at its disposal and knows the bandwidths reserved for the traffic and for the protection on each of the links of the network. It also takes into account the specifications of the operator with respect to the elements which are not capable of being protected and/or those which cannot be used for the protection.

According to a second embodiment, which is of the distributed type, when a path is established through the network, the input router can specify that the path in question should be the object of the protection. To do so, an upgrade of the IGP protocol (or of the ISIS or OSPF protocols which are IGP protocols already upgraded for traffic engineering) is provided permitting, according to a flooding mechanism, to inform each node not only of the topology of the network and of the created tunnels, as in the state of the art, but also of the already created bypass tunnels and the respective elements protected by these tunnels. The local database (TED) of each node therefore contains information indicating the created bypass tunnels with their characteristics (NHOP, NNHOP, path, bandwidth, for example) as well as the elements which they protect. When a bypass tunnel is created or destroyed, the nodes of the network are advised thereof by means of creation/destruction messages permitting the updating of their respective databases.

The protection is requested by the input router by means of the “path” message of the RSVP-TE protocol mentioned in the introductory part. More precisely, this router incorporates the following information in the session attribute object (SAO):
A local protection desired (LPD) bit indicating to transit router that a local protection of the path is required;
a node protection desired (NPD) bit indicating to each transit router that a bypass tunnel of the NNHOP type is required; otherwise a bypass tunnel of the NHOP type is used;
a bandwidth protection desired (BPD) bit indicating to each transit router that a bandwidth protection is required; that is, that the bypass tunnel should offer a bandwidth at least equal to that of the path to be protected.

When a transit router R on the path in question receives a “path” message of the RSVP-TE protocol, it first searches whether a protection and what type (NHOP, NNHOP) of protection is required. Depending on the case, the protection concerns either the link or the node downstream of the router on the path. The router R then searches in its local database whether at least one bypass tunnel already exists which passes through R. If this is not so, it searches whether it can construct a bypass tunnel partially or entirely using existing bypass tunnel elements. The router thus obtains a certain number of bypass tunnel candidates which are subjected to the selection stages (2) to (5) indicated above. If one of the candidates is retained, the router, after having received the reception of the message “RESV” of the RSVP protocol, effectively creates the bypass tunnel and assigns the necessary bandwidth to it. For each link L constituting the bypass tunnel, a bandwidth reservation rBP(L)=max (BP(Φ,L)) or Φ ε LFRG(L) is then made. If the transit router cannot establish the bypass tunnel, for example, because of an insufficient bandwidth, it will inform the input router correspondingly.

It is clear to a person skilled in the art that the protection request and the reservation acknowledgement can also be transmitted by means of the CR-LDP protocol instead and in place of the RSVP-TE protocol.

1-6. (canceled)

7. A method of protecting label switching paths in an MPLS network having a plurality of nodes connected by IP links, a path passing through a determined series of nodes and links of said network, the nodes and links being called elements of said path, an element of a path being protectable by at least one bypass tunnel of said path, each bypass tunnel starting from a node of said path upstream of said element to be protected and ending in a node of said path downstream of said element to be protected, the method comprising, for an element of the path to be protected from failure, the steps of:
determining for each physical element of said network a group of shared links of said network reached as a result of the failure of said physical element;
determining, for each link of said network, a list of said groups to which a particular link belongs;
selecting a bypass tunnel, called a bypass tunnel candidate, from among a set of bypass channels capable of protecting said element of the path to be protected;
determining whether the lists of the groups respectively associated with the link including said element to be protected or with the link upstream of said element to be protected and with each link of the tunnel candidate are disjointed;
responding to the disjointed determining step by testing whether each link of the bypass tunnel candidate presents a failure risk independently of the failure risk of said link to be protected or said link upstream;
if a particular link is determined not to be a failure risk, preventing use of said bypass tunnel and selecting another bypass tunnel candidate from among all those capable of protecting said element of the path and then restarting the previous stages;
if a particular link is determined to be a failure risk, checking whether the bandwidth to be reserved on each link of said bypass tunnel candidate for supporting said bypass tunnel or all said bypass paths passing through said link is lower than or equal to the maximal bandwidth of said link reservable for the protection; and
if the bandwidth check is positive, retaining the bypass tunnel candidate; or
if the bandwidth check is negative, preventing use of the bypass tunnel candidate.

8. A method according to claim 7, wherein for the element to be protected from a failure being a link, the determination of whether each of said links including said bypass tunnel candidate presents a failure risk is performed independently of the failure of risk of said link.

9. A method according to claim 7, wherein for the element to be protected from a failure being a node, the determination of whether each of said links including said bypass tunnel candidate presents a failure risk is performed independently of the failure risk of the (a) link upstream of the node to be protected, (b) link adjoining the node upstream of said node to be protected, and (c) node to be protected.

10. A method according to claim 7, wherein the maximal bandwidth of a link reservable for protection is the maximal sum of all bandwidths of the bypass tunnels which pass through the link reservable for protection and that are simultaneously active.

11. A centralized server for determining the bypass tunnels in accordance with the method of claim 7.

12. A centralized server for determining the bypass tunnels in accordance with the method of claim 8.

13. A centralized server for determining the bypass tunnels in accordance with the method of claim 9.

14. A centralized server for determining the bypass tunnels in accordance with the method of claim 10.

15. A processor of a node upstream of a node to be protected in accordance with the method of claim 7 for determining a bypass tunnel of an element of a path to be protected.

16. A processor of a node upstream of a node to be protected in accordance with the method of claim 8 for determining a bypass tunnel of an element of a path to be protected.

17. A processor of a node upstream of a node to be protected in accordance with the method of claim 9 for determining a bypass tunnel of an element of a path to be protected.

18. A processor of a node upstream of a node to be protected in accordance with the method of claim 10 for determining a bypass tunnel of an element of a path to be protected.
